(19) United States
(12) Patent Application Publication
(10) Pub. No.: US 2026/0233714 A1
(43) Pub. Date: Aug. 13, 2026

(54) DRIVING ASSISTANCE APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kento OISHI, Tokyo (JP); Shimpei HIGASHINO, Atsugi-shi (JP)

(21) Appl. No.: 19/536,897

(22) Filed: Feb. 11, 2026

(30) Foreign Application Priority Data
Feb. 13, 2025 (JP) 2025-021276

(51) Int. Cl. B60T 7/12; B60T 8/17

(52) U.S. Cl. CPC B60T 7/12; B60T 8/17; B60T 2210/32

(57) ABSTRACT

A driving assistance apparatus for a moving body is provided. The moving body includes a sensor and a braking apparatus. The sensor detects a first target ahead of the moving body and a second target present to a side of the moving body. Compared to a braking force in case where a collision with the first target is predicted, the driving assistance apparatus reduces the braking force, in response to the collision with the second target being predicted and a target direction that is a moving direction of the second target not being opposing a moving body direction that is a travelling direction of the moving body during turning of the moving body, and does not reduce the braking force, in response to the collision with the second target being predicted and the target direction being opposing the moving body direction during turning of the moving body.

### CROSS-REFERENCE TO RELATED APPLICATIONS

This application is based on and claims the benefit of priority from Japanese Patent Application No. 2025-021276, filed on February 13, 2025. The entire disclosure of the above application is incorporated herein by reference.

### BACKGROUND

The present disclosure relates to a driving assistance apparatus. Various technologies for predicting a collision of a vehicle and braking the vehicle have been proposed.

### SUMMARY

An aspect of the present disclosure provides a driving assistance apparatus for a moving body. The moving body includes a sensor that detects a target in a vicinity of the moving body and a braking apparatus that applies a braking force to the moving body when a collision between the moving body and the moving target is predicted to occur. The sensor detects a first target that is moving target present ahead of the moving body and a second target that is a moving target present to a side of the moving body. The driving assistance apparatus adjusts the braking force. Compared to the braking force in a case where a collision with the first target is predicted, the driving assistance apparatus reduces the braking force in response to a collision with the second target being predicted and a target direction that is a moving direction of the second target not being opposing a moving body direction that is a travelling direction of the moving body during turning of the moving body, and does not reduce the braking force in response to the collision with the second target being predicted and the target direction being opposing the moving body direction during turning of the moving body.

### BRIEF DESCRIPTION OF THE DRAWINGS

In the accompanying drawings:

FIG. 1 is a block diagram illustrating an overall configuration of a driving assistance apparatus according to an embodiment of the present disclosure;

FIG. 2 is a diagram for explaining an opposing state;

FIG. 3 is a diagram for explaining determination of the opposing state using a velocity vector;

FIG. 4 is a diagram for explaining adjustment of a braking force according to a first embodiment;

FIG. 5 is a flowchart illustrating steps in a process for adjusting the braking force; and

FIG. 6 is a diagram for explaining adjustment of a braking force according to a second embodiment.

### DESCRIPTION OF THE EMBODIMENTS

For example, JP-A-2024-050120 discloses a technology in which, when a collision with a target present to the side of a vehicle is predicted, a braking force that is less than the braking force when a collision with a target present ahead of the vehicle is predicted is applied to the vehicle. As a result, likelihood of an occupant of the vehicle experiencing discomfort is reduced when a collision with a target present in a position not easily visible to the occupant is predicted.

If the technology in JP-A-2024-050120 is applied during turning of the vehicle, when a collision with a target present to the side of the vehicle is predicted, the occupant may experience discomfort as a result of a small braking force being applied regardless of the target being visible to the occupant. Therefore, there is room for improvement in the adjustment of the braking force during turning of the vehicle.

The present disclosure can be implemented according to the following exemplary embodiment.

An exemplary embodiment of the present disclosure provides a driving assistance apparatus for a moving body. The moving body includes a sensor that detects a target in a vicinity of the moving body, the sensor detecting a first target that is moving target present ahead of the moving body and a second target that is a moving target present to a side of the moving body, and a braking apparatus that applies a braking force to the moving body when a collision between the moving body and the moving target is predicted to occur. The driving assistance apparatus includes at least one of (i) a circuit and (ii) a processor with a memory storing computer program code executable by the processor, the at least one of the circuit and the processor configured to implement: an adjustment unit that adjusts the braking force. The adjustment unit reduces the braking force in response to a collision with the second target being predicted and a target direction that is a moving direction of the second target not being opposing a moving body direction that is a travelling direction of the moving body during turning of the moving body, compared to the braking force in a case where a collision with the first target is predicted. The adjustment unit does not reduce the braking force when the collision with the second target is predicted and the target direction is opposing the moving body direction during turning of the moving body, compared to the braking force when a collision with the first target is predicted.

In the driving assistance apparatus according this exemplary embodiment, during turning of the moving body, the adjustment unit (1) reduces the braking force when a collision with the second target is predicted and the target direction is not opposing the moving body direction, compared to the braking force when a collision with the first target is predicted, and (2) does not reduce the braking force when a collision with the second target is predicted and the target direction is opposing the own vehicle direction, compared to the braking force when a collision with the first target is predicted. Therefore, occurrence of discomfort experienced by an occupant when a collision is predicted during turning can be suppressed. Specifically, in the case of (1), the second target is highly likely not to be visible to the occupant of the moving body. The braking force applied in such a case is less than that applied when a collision with the first target that is highly likely to be visible to the occupant is predicted. Therefore, occurrence of discomfort experienced by the occupant can be suppressed. In addition, in the case of (2), the second target is highly likely to be visible to the occupant. The braking force applied in such a case is not reduced as in the case of (1). Therefore, compared to a configuration in which the braking force is uniformly reduced when a collision with a moving target present to the side is predicted, occurrence of discomfort experienced by the occupant can be suppressed.

### A. First embodiment

### Overview of a driving assistance apparatus 1

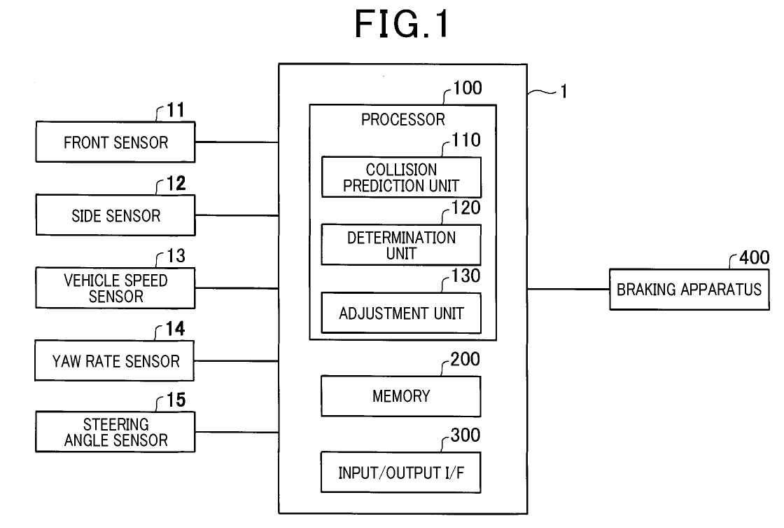

A driving assistance apparatus 1 shown in FIG. 1 is used so as to be mounted in a vehicle. The driving assistance apparatus 1 predicts whether a collision with a target present in the vicinity of the vehicle will occur, using detection results from various sensors mounted in the vehicle. In addition, the driving assistance apparatus 1 adjusts a braking force applied to the vehicle when the collision with the target is predicted. Here, the vehicle in which the driving assistance apparatus 1 is mounted may also be referred to, hereafter, as an own vehicle.

The “target” in the present disclosure is an object to be detected by the various sensors mounted in the vehicle. For example, the target may be a pedestrian, a bicycle, an animal, a vehicle other than the own vehicle, a building, a utility pole, a tree, or the like. Among these targets, a target that is other than an immovable object (immovable property or real estate) and is able to be moved is referred to as a “moving target”.

### Configuration of the sensors

As shown in FIG. 1, signals are transmitted to the driving assistance apparatus 1 from a plurality of sensors through an input/output interface (I/F) 300. The plurality of sensors shown in FIG. 1 are mounted in the vehicle in which the driving assistance apparatus 1 is mounted. The plurality of sensors include a front sensor 11, a side sensor 12, a vehicle speed sensor 13, a yaw rate sensor 14, and a steering angle sensor 15.

The front sensor 11 detects a moving target present in an area including that ahead of the own vehicle. The side sensor 12 detects a moving target present in an area including that to the side of the own vehicle. Here, in the present disclosure, “to the side of the own vehicle” also includes ahead-and-to-the-side and behind-and-to-the-side of the own vehicle. For example, ahead-and-to-the-side and behind-and-to-the-side each refer to an area rotated by 30 degrees to 60 degrees from an axis that runs along a longitudinal direction (advancing-reversing direction) of the own vehicle and passes through a center of the own vehicle in a lateral direction. For example, the front sensor 11 and the side sensor 12 may be a camera or a distance measurement apparatus. The distance measurement apparatus may be, for example, an apparatus to which a millimeter-wave radar or Light Detection and Ranging (LiDAR) is applied. For example, the front sensor 11 may be provided in the center of a front bumper of the own vehicle. For example, the side sensor 12 may be provided on each of left and right end portions of the front bumper of the own vehicle. The detection areas of the front sensor 11 and the side sensor 12 may partially overlap each other. The front sensor 11 and the side sensor 12 correspond to an example of a “sensor that detects a target in a vicinity of a vehicle” in the present disclosure.

The vehicle speed sensor 13 generates a signal corresponding to a traveling speed of the own vehicle. For example, the vehicle speed sensor 13 may detect a number of rotations of a tire of the own vehicle. The signal emitted by the vehicle speed sensor 13 is used for calculation of the traveling speed of the own vehicle by the driving assistance apparatus 1.

The yaw rate sensor 14 generates a signal corresponding to a yaw rate acting on the own vehicle. The signal emitted by the yaw rate sensor 14 is used for calculation of the yaw rate of the own vehicle by the driving assistance apparatus 1.

The steering angle sensor 15 transmits a steering angle signal corresponding to a steering angle of the own vehicle to the driving assistance apparatus 1. For example, the steering angle sensor 15 may be attached to a steering rod of the own vehicle.

### Configuration of a braking apparatus 400

A braking apparatus 400 applies a braking force to the own vehicle to brake the own vehicle. The braking apparatus 400 applies the braking force in response to an instruction from an occupant of the own vehicle or an instruction from the driving assistance apparatus 1. The instruction from the occupant is issued through use of an input apparatus such as a brake pedal. The instruction from the driving assistance apparatus 1 is issued through transmission of electrical signals.

### Configuration of the driving assistance apparatus 1

The driving assistance apparatus 1 includes a processor 100, a memory 200, and an input/output interface I/F 300. Here, the driving assistance apparatus 1 may be configured as a part of an electronic control unit (ECU) that performs various types of control of the own vehicle.

The processor 100 functions as a collision prediction unit 110, a determination unit 120, and an adjustment unit 130 by executing a program stored in the memory 200.

### Functions of the collision prediction unit 110

The collision prediction unit 110 predicts whether a collision between the own vehicle and a target in the vicinity of the own vehicle will occur. Specifically, the collision prediction unit 110 predicts whether a collision will occur by calculating whether a predicted movement trajectory of the own vehicle and a predicted movement trajectory of the target intersect. The movement trajectory of the own vehicle is predicted using the traveling speed, the steering angle, and the yaw rate of the own vehicle. The movement trajectory of the target is predicted using the detection results of the front sensor 11 and the side sensor 12. More specifically, the movement trajectory of the target is predicted using transitions in a position of the target detected by the front sensor 11 and the side sensor 12.

When predicted that the own vehicle and the target will collide, the collision prediction unit 11 transmits an instruction to the braking apparatus 400 to apply a braking force to the own vehicle. As a result, the collision between the own vehicle and the target is suppressed.

### Functions of the determination unit 120

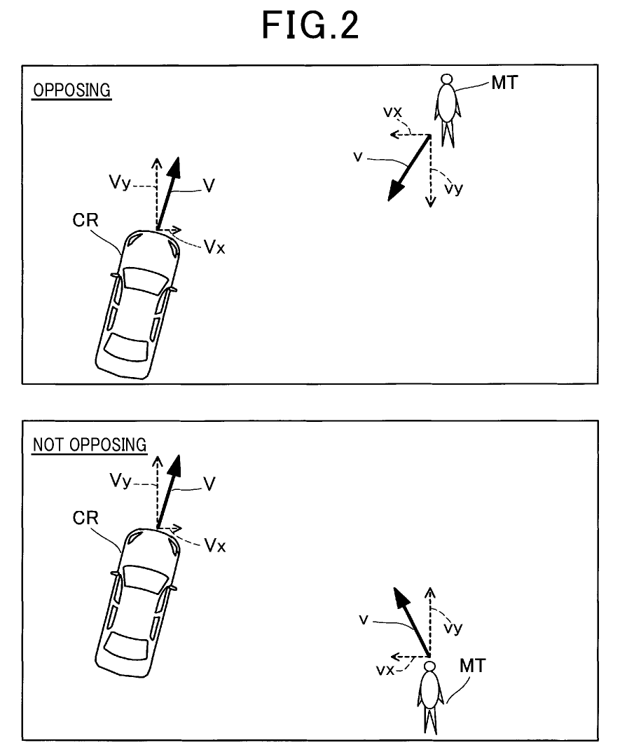

The determination unit 120 determines whether a moving direction of the target in the vicinity of the own vehicle is opposing a travelling direction of the own vehicle during turning of the own vehicle. The term “opposing” in the present disclosure will be explained with reference to FIG. 2.

On an upper side of FIG. 2, a state in which a travelling direction V of an own vehicle CR and a moving direction v of a moving target MT are opposing is shown. On a lower side of FIG. 2, a state in which the travelling direction V of the own vehicle CR and the moving direction v of the moving target MT are not opposing is shown. FIG. 2 shows a planar view of the own vehicle CR from above. FIG. 2 also shows a state in which the own vehicle CR is beginning to turn right. Here, the moving object MT in the description hereafter is a pedestrian.

In FIG. 2, a direction Vx and a direction Vy are shown. The direction Vx and the direction Vy are directions obtained by decomposing the travelling direction V of the vehicle. The direction Vx is parallel to the lateral direction (width direction) of the own vehicle CR. The direction Vy is parallel to the longitudinal direction of the own vehicle CR. In a similar manner, two directions vx and vy obtained by decomposing the moving direction v of the moving target MT are shown in FIG. 2. The direction vx is parallel to the lateral direction (width direction) of the own vehicle CR. The direction vy is parallel to the longitudinal direction of the own vehicle CR.

“The travelling direction V of the own vehicle CR and the moving direction v of the moving target MT are opposing” in the present disclosure refers to a state in which, among components of the travelling direction V and the moving direction v, components that are parallel to the longitudinal direction of the own vehicle CR (that is, the direction Vy and the direction vy) are compared and determined to be in opposite directions. Therefore, as shown in the lower side of FIG. 2, a state in which the direction Vy and the direction vy are facing the same direction indicates that the direction Vy and the direction vy are “not opposing”.

Here, the determination unit 120 determines whether travelling direction V of the own vehicle CR and the moving direction v of the moving target MT are opposing based on the direction Vy immediately after turning of the own vehicle CR. The turning of the own vehicle CR can be detected using at least either of the detection of the steering angle and a change in yaw rate.

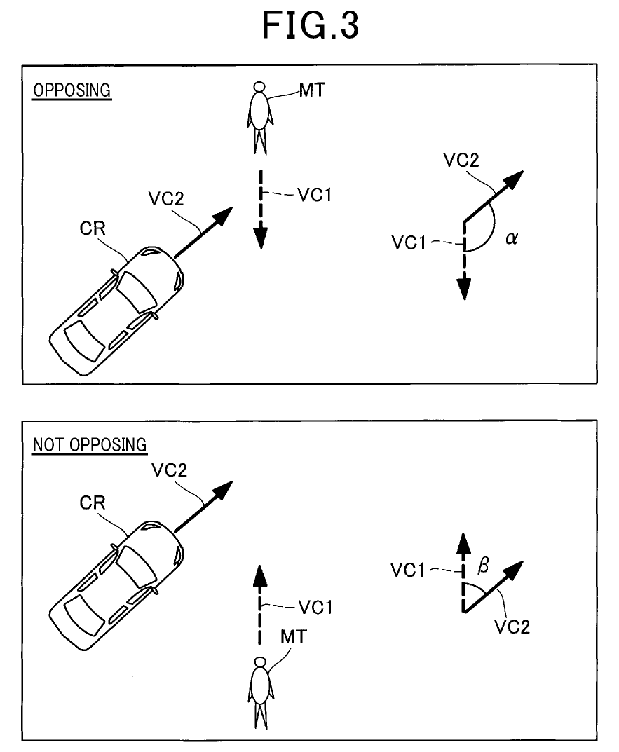

The determination unit 120 according to the present embodiment determines whether a “target direction” that is a direction in which the moving target MT is moving and an “own vehicle direction” that is a direction in which the own vehicle CR is moving are opposing, using a first vector that is a velocity vector of the moving target MT and a second vector that is a velocity vector of the own vehicle CR. More specifically, the determination unit 120 determines that the target direction and the own vehicle direction are opposing when an angle formed by the first vector and the second vector is within a predetermined range, and determines that the target direction and the own vehicle direction are not opposing when the angle formed by the first vector and the second vector is outside the predetermined range. The determination of the opposing state using the velocity vectors will be described with reference to FIG. 3.

On an upper side of FIG. 3, a state in which the own vehicle direction and the target direction are opposing is shown. On a lower side of FIG. 3, a state in which the own vehicle direction and the target direction are not opposing is shown. In a manner similar to FIG. 2, FIG. 3 shows a planar view of the own vehicle CR from above. In addition, FIG. 3 shows a state in which the own vehicle CR is turning right.

A first vector VC1 that is the velocity vector of the moving target MT is calculated using the detection results of the front sensor 11 and the side sensor 12. More specifically, the first vector VC1 is calculated by a transition between frames of the moving target MT detected by the front sensor 11 and the side sensor 12 being detected. A known technique such as optical flow can be used to calculate the first vector VC1. In addition, a second vector VC2 that is the velocity vector of the own vehicle CR is calculated using the traveling speed and the yaw rate of the own vehicle CR, by a method similar to that for the first vector VC1. The first vector VC1 and the second vector VC2 according to the present embodiment are those identified at a current point in time.

As shown on a right side of FIG. 3, an angle formed by the first vector VC1 and the second vector VC2 is determined by starting points of the first vector VC1 and the second vector VC2 being overlapped. In an example shown on the upper side of FIG. 3, the angle formed by the first vector VC1 and the second vector VC2 is α. In an example shown on the lower side in FIG. 3, the angle formed by the first vector VC1 and the second vector VC2 is β. The determination unit 120 determines whether the angle formed by the first vector VC1 and the second vector VC2 is within a range prescribed in advance. For example, the range prescribed in advance may be greater than 90 degrees. The range prescribed in advance is stored in advance in the memory 200 shown in FIG. 1. The angle α shown on the upper side of FIG. 3 is greater than 90 degrees. In the example shown on the upper side of FIG. 3, the determination unit 120 determines that the own vehicle direction and the target direction are opposing. In contrast, the angle β shown on the lower side of FIG. 3 is less than 90 degrees. In the example shown on the lower side of FIG. 3, the determination unit 120 determines that the own vehicle direction and the target direction are not opposing.

The determination unit 120 transmits a result indicating whether the own vehicle direction and the target direction are opposing to the adjustment unit 130, described hereafter.

Here, the determination process using the first vector VC1 and the second vector VC2 identified at the current point in time as described above is also referred to as a “first determination process”.

### Functions of the adjustment unit 130

The adjustment unit 130 shown in FIG. 1 adjusts the braking force applied by the braking apparatus 400. The adjustment unit 130 according to the present embodiment adjusts the braking force based on the position and the moving direction of the moving target, when the collision prediction unit 110 predicts that the own vehicle CR and the moving object will collide. A moving target positioned ahead of the own vehicle CR is also referred to, hereafter, as a “first target”. A moving target positioned to the side of the own vehicle CR is also referred to, hereafter, as a “second target”. The first target can be detected by the front sensor 11. The second target can be detected by the side sensor 12.

When the collision prediction unit 110 predicts that the own vehicle CR and the first target will collide during turning of the own vehicle CR, the adjustment unit 130 transmits a control signal to the braking apparatus 400 to apply a first braking force to the own vehicle.

In addition, when the collision prediction unit 110 predicts that the own vehicle CR and the second target will collide during turning of the own vehicle CR, and the determination unit 120 determines that the travelling direction of the own vehicle CR and the moving direction of the second target are not opposing, the adjustment unit 130 transmits a control signal to the braking apparatus 400 to apply a second braking force. The second braking force is less than the first braking force. The adjustment unit 130 can also be said to apply a braking force that has been reduced from the first braking force.

Furthermore, when the collision prediction unit 110 predicts that the own vehicle CR and the second target will collide during turning of the own vehicle CR, and the determination unit 120 determines that the travelling direction of the own vehicle CR and the moving direction of the second target are opposing, the adjustment unit 130 transmits a control signal to the braking apparatus 400 to apply a third braking force. The third braking force is equal to or greater than the first braking force. The adjustment unit 130 can also be said to apply a braking force that has not been reduced from the first braking force.

### Detailed description of braking force adjustment by the adjustment unit 130

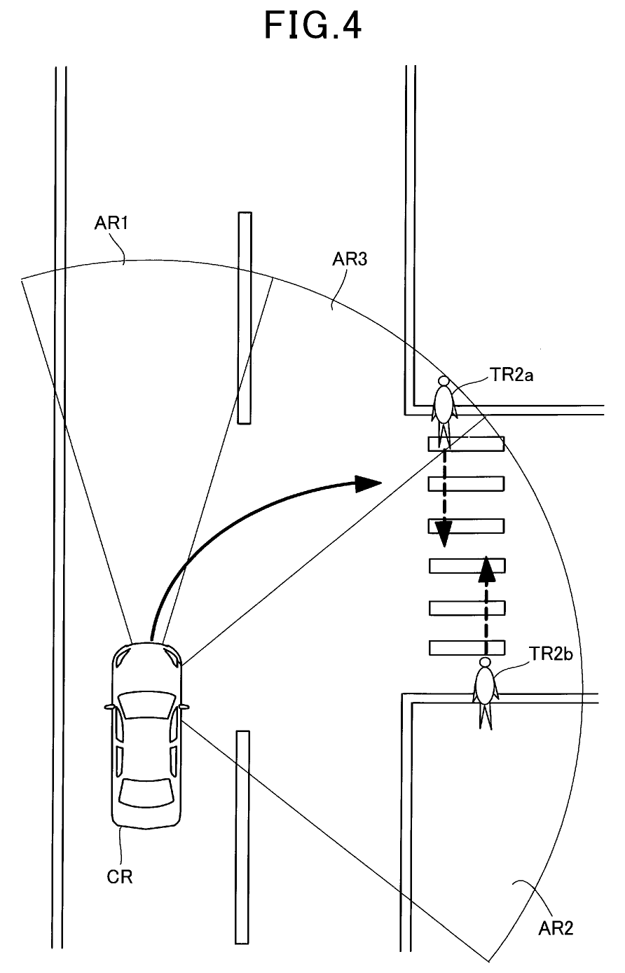

The adjustment of the braking force by the adjustment unit 130 when the collision with the second target is predicted as described above will be described with reference to FIG. 4. FIG. 4 shows a state in which the own vehicle CR is turning right. In addition, FIG. 4 also schematically shows a detection area AR1 of the front sensor 11, a detection area AR2 of the side sensor 12, and a detection area AR3 in which the detection areas of the front sensor 11 and the side sensor 12 overlap. Furthermore, FIG. 4 also shows a second target TR2a that has a moving direction opposing the travelling direction of the own vehicle CR, and a second target TR2b that has a moving direction not opposing the travelling direction of the own vehicle CR.

The second target TR2a that has the moving direction opposing the travelling direction of the own vehicle CR is detected by the front sensor 11 and the side sensor 12. The second target TR2a such as this is relatively highly likely to be visible to the occupant. Therefore, even should a relatively large braking force be applied when a collision between the second target TR2a and the own vehicle CR is predicted, the occupant is unlikely to experience discomfort.

The second target TR2b that has the moving direction not opposing the travelling direction of the own vehicle CR is detected by the side sensor 12 in a manner similar to the second target TR2a. However, unlike the second target TR2a, the second target TR2b such as this is relatively less likely to be visible to the occupant. Therefore, should a relatively large braking force be applied when a collision between the second target TR2b and the own vehicle CR is predicted, the occupant is highly likely to experience discomfort.

Here, the adjustment unit 130 changes the braking force to be applied depending on whether the second target TR2a or the second target TR2b is opposing. Specifically, the adjustment unit 130 transmits a control signal to the braking apparatus 400 to apply a relatively large braking force for the second target TR2a that is relatively highly likely to be visible to the occupant. The “relatively large braking force” refers to a braking force equal to or greater than the braking force applied when a collision with the first target present ahead of the own vehicle CR is predicted. That is, the adjustment unit 130 can be said to not reduce the braking force for the second target TR2a, compared to the braking force for the first target.

In addition, the adjustment unit 130 transmits a control signal to the braking apparatus 400 to apply a relatively small braking force for the second target TR2a that is relatively less likely to be visible to the occupant. The “relatively small braking force” refers to a braking force that is less than the braking force applied when a collision with the first object present ahead of the own vehicle CR is predicted.

As a result of adjustment of the braking force by the adjustment unit 130 as described above, when a collision between the second target TR2a or TR2b and the own vehicle CR is predicted, occurrence of discomfort experienced by the occupant can be suppressed regardless of whether the second target TR2a or TR2b is present in a position that is highly likely to be visible to the occupant.

### Braking force adjustment process

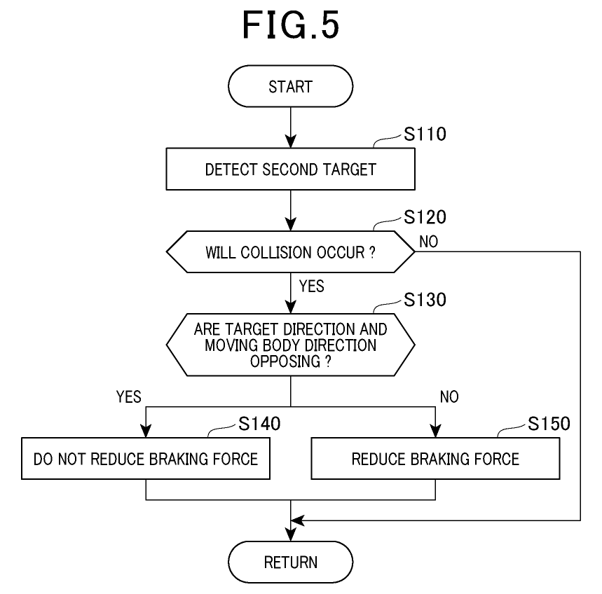

An adjustment process for the braking force shown in FIG. 5 is performed when the turning of the own vehicle CR starts. The adjustment process is repeatedly performed while the own vehicle CR is turning. The side sensor 12 detects a second target TR that is present to the side of the own vehicle CR (step S110). “Step S” will hereafter be simply denoted as “S”.

The collision prediction unit 110 predicts whether a collision between the own vehicle CR and the second target TR will occur (S120). When the prediction is that the own vehicle CR and the second target TR will not collide (NO at S120), the adjustment process is ended.

When the prediction is that the own vehicle CR and the second target TR will collide (YES at S120), the determination unit 120 determines whether the moving direction of the second target TR and the travelling direction of the own vehicle CR are opposing (S130).

When determined that the moving direction and the travelling direction are opposing (YES at S130), the determination unit 120 transmits the control signal to the braking apparatus 400 to apply a braking force that is equal to or greater than the braking force applied when a collision with the first target is predicted (S140).

When determined that the moving direction and the travelling direction are not opposing (NO at S130), the determination unit 120 transmits the control signal to the braking apparatus 400 to apply a braking force that is less than the braking force applied when a collision with the first target is predicted (S150).

In the driving assistance apparatus 1 according to the first embodiment described above, during turning of the vehicle, the adjustment unit 130 (1) reduces the braking force, compared to the braking force when a collision with the first target is predicted, when a collision with the second target TR2b is predicted and the target direction is not opposing the own vehicle direction, and (2) does not reduce the braking force, compared to the braking force when a collision with the first target is predicted, when a collision with the second target TR2b is predicted and the target direction is opposing the own vehicle direction. Therefore, occurrence of discomfort experienced by the occupant when a collision is predicted during turning can be suppressed. Specifically, in the case of (1), the second target TR2b is highly likely not to be visible to the occupant of the own vehicle CR. The braking force applied in such a case is less than that applied when a collision with the first target that is highly likely to be visible to the occupant is predicted. Therefore, occurrence of discomfort experienced by the occupant can be suppressed. In addition, in the case of (2), the second target TR2a is highly likely to be visible to the occupant. The braking force applied in such a case is not reduced as in the case of (1). Therefore, compared to a configuration in which the braking force is uniformly reduced when a collision with a moving target present to the side is predicted, occurrence of discomfort experienced by the occupant can be suppressed.

In addition, in the driving assistance apparatus 1 according to the first embodiment, the determination unit 120 performs the determination using the first vector VC1 and the second vector VC2 identified at the current point in time. Therefore, the determination can be performed relatively early, from a point in time before a point in time at which the collision is predicted.

### B. Second embodiment

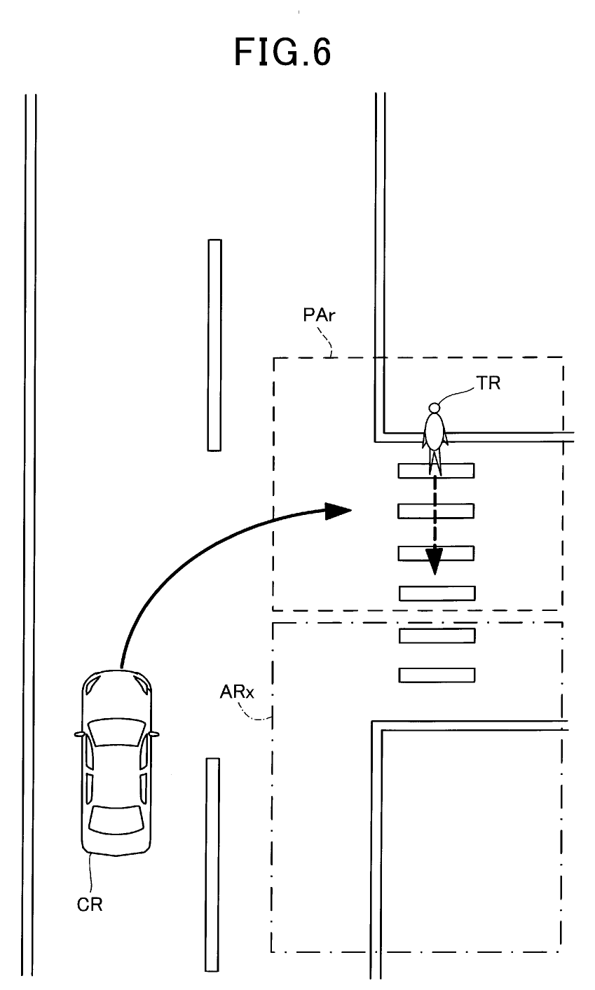

In an operational example of the driving assistance apparatus 1 according to a second embodiment shown in FIG. 6, a method by which the determination unit 120 determines the opposing state differs from that of the driving assistance apparatus 1 according to the first embodiment. Other configurations of the driving assistance apparatus 1 according to the second embodiment are similar to those of the driving assistance apparatus 1 according to the first embodiment. Therefore, descriptions thereof are omitted.

The determination unit 120 according to the present embodiment determines that the target direction and the own vehicle direction are opposing when the second target TR is present within an area PAr prescribed in advance, and determines that the target direction and the own vehicle direction are not opposing when the second target TR is not present within the area PAr prescribed in advance.

In an example shown in FIG. 6, the area PAr prescribed in advance is indicated by broken lines to the side and ahead of the own vehicle CR. The area PAr is stored in advance in the memory 200. For example, the area PAr may be positioned to the side of the own vehicle CR and ahead of a mounting position of the side sensor 12. The second target TR present within the area PAr is relatively more likely to be opposing the own vehicle CR than the second target TR present within an area ARx that is an area to the side of the own vehicle CR other than the area PAr. Therefore, the determination unit 120 determines whether the target direction and the own vehicle direction are opposing during turning, depending on whether the second target TR within the area PAr is present.

In the driving assistance apparatus 1 according to the second embodiment described above, the determination unit 120 determines whether the target direction and the own vehicle direction are opposing using a relative positional relationship between the second target TR and the vehicle CR. Therefore, the determination can be performed with relative ease.

In addition, in the driving assistance apparatus 1 according to the second embodiment, the determination unit 120 determines that the target direction and the own vehicle direction are opposing when the second target TR is present within the area PAr prescribed in advance, and determines that the target direction and the own vehicle direction are not opposing when the second target TR is not present within the area PAr prescribed in advance. Therefore, the determination can be performed with relative ease. Furthermore, whether the target direction and the own vehicle direction are opposing can be determined with accuracy by the area PAr prescribed in advance being appropriately determined.

Here, the driving assistance apparatus 1 according to the second embodiment may be used in combination with the driving assistance apparatus 1 according to the first embodiment. That is, the determination unit 120 may determine that the target direction and the own vehicle direction are opposing when the first vector VC1 and the second vector VC2 are within a range prescribed in advance, and the second target TR is present within the area PAr prescribed in advance. As a result of a configuration such as this, whether the target direction and the own vehicle direction are opposing can be determined with further accuracy.

### C. Other embodiments

(C1) According to the above-described first embodiment, the determination unit 120 performs the determination using the first vector VC1 and the second vector VC2 identified at the current point in time. However, the present disclosure is not limited thereto. The determination unit 120 may perform the determination using the first vector VC1 and the second vector VC2 at an arbitrary point in time. For example, the determination unit 120 may perform the determination using the first vector VC1 and the second vector VC2 estimated at the point in time at which the second target TR and the own vehicle CR are predicted to collide. A process such as this is also referred to as a “second determination process”. The first vector VC1 and the second vector VC2 in this case are estimated using the movement trajectory of the own vehicle and the movement trajectory of the target predicted by the collision prediction unit 110. As a result of a configuration such as this, the determination is performed through use of the first vector VC1 and the second vector VC2 at the point in time at which the second target TR and the own vehicle CR are predicted to collide. Therefore, the determination can be performed based on the prediction of the collision.

In addition, the determination unit 120 may determine that the target direction and the own vehicle direction are opposing when the target direction and the own vehicle direction are determined to be opposing in both the first determination process and the second determination process, described above. That is, the determination unit 120 determines that the target direction and the own vehicle direction are opposing only when the target direction and the own vehicle direction are determined to be opposing in both the first determination process using the first vector VC1 and the second vector VC2 identified at the current point in time, and the second determination process using the first vector VC1 and the second vector VC2 identified at the point in time at which the collision is predicted. The determination unit 120 determines that the target direction and the own vehicle direction are not opposing when the target direction and the own vehicle direction are determined not to be opposing in at least either of the first determination process and the second determination process. As a result of the configuration such as this, the determination unit 120 determines that the target direction and the own vehicle direction are opposing when the target direction and the own vehicle direction are determined to be opposing in both the first determination process and the second determination process. Therefore, compared to a configuration in which the determination of the opposing state is performed based on only either of the first determination process and the second determination process, the determination can be more accurately performed.

(C2) According to the above-described second embodiment, the determination unit 120 determined whether the target direction and the own vehicle direction are opposing based on whether the second target TR is present in the area PAr prescribed in advance. However, the present disclosure is not limited thereto. The determination unit 120 may determine whether the target direction and the own vehicle direction are opposing by an arbitrary method that uses the relative positional relationship between the second target TR and the own vehicle CR. For example, the determination unit 120 may determine whether the target direction and the own vehicle direction are opposing based on whether the second target TR is present within an angular range prescribed in advance, viewed from the own vehicle CR.

(C3) According to the above-described embodiments, the adjustment unit 130 transmits the control signal to the braking apparatus 400 to reduce the braking force, compared to the braking force when the collision with the first target is predicted, when the target direction and the own vehicle direction are not opposing. After this adjustment of the braking force, the adjustment unit 130 may transmit a control signal to the braking apparatus 400 to increase the braking force. That is, when a collision with the second target TR that is not opposing the own vehicle direction is predicted, a relatively large braking force may be applied after a relatively small braking force is applied. As a result of a configuration such as this, when a collision with the second target that is less likely to be visible to the occupant is predicted, occurrence of the collision with the second target can be further suppressed while the occurrence of discomfort experienced by the occupant is also suppressed.

(C4) According to the above-described embodiments, the adjustment unit 130 adjusts the braking force by transmitting a control signal to the braking apparatus 400. However, the present disclosure is not limited thereto. For example, the adjustment unit 130 may adjust the braking force by transmitting a control signal to a drive apparatus to reduce the vehicle speed.

(C5) According to the above-described embodiments, the driving assistance apparatus 1 is mounted in a vehicle. However, the present disclosure is not limited thereto. The driving assistance apparatus 1 may be mounted in an arbitrary moving body. For example, the moving body may be a ship, an aircraft, a so-called flying car, or the like.

(C6) The driving assistance apparatus 1 and a method thereof described in the present disclosure may be implemented by a dedicated computer that is provided so as to be configured by a processor and a memory, the processor being programmed to provide one or more functions that are implemented by a computer program. Alternatively, the driving assistance apparatus 1 and a method thereof described in the present disclosure may be implemented by a dedicated computer that is provided by a processor being configured by one or more dedicated hardware logic circuits. Still alternatively, the driving assistance apparatus 1 and a method thereof described in the present disclosure may be implemented by one or more dedicated computers. The dedicated computer may be configured by a combination of a processor that is programmed to provide one or more functions, a memory, and a processor that is configured by a single hardware logic circuit or more. In addition, the computer program may be stored in a non-transitory, computer-readable, tangible storage medium that can be read by a computer as instructions performed by the computer.

The present disclosure is not limited to the above-described embodiments and can be actualized by various configurations without departing from the spirit of the disclosure. For example, technical features according to embodiments that correspond to technical features in each aspect described in the summary of the disclosure can be replaced and combined as appropriate to solve some or all of the above-described issues or to achieve some or all of the above-described effects. Furthermore, the technical features may be omitted as appropriate unless described as a requisite in the present specification. The present disclosure can be implemented according to aspects such as a method for driving assistance, a computer program for implementing this method, and a non-transitory computer-readable storage medium in which the computer program is stored.

For example, the present disclosure may be implemented according to following aspects.

### Aspect 1

A driving assistance apparatus (1) for a moving body (CR), the moving body including a sensor (11, 12) that detects a target in a vicinity of the moving body, the sensor detecting a first target that is moving target present ahead of the moving body and a second target (TR, TR2a, TR2b) that is a moving target present to a side of the moving body, and a braking apparatus (400) that applies a braking force to the moving body when a collision between the moving body and the moving target is predicted to occur, the driving assistance apparatus including: at least one of (i) a circuit and (ii) a processor with a memory storing computer program code executable by the processor, the at least one of the circuit and the processor configured to implement: an adjustment unit (130) that adjusts the braking force, wherein the adjustment unit reduces the braking force, compared to the braking force in a case where a collision with the first target is predicted, in response to a collision with the second target being predicted and a target direction that is a moving direction of the second target not being opposing a moving body direction that is a travelling direction of the moving body during turning of the moving body, and does not reduce the braking force, compared to the braking force in a case where a collision with the first target is predicted, in response to the collision with the second target being predicted and the target direction being opposing the moving body direction during turning of the moving body.

### Aspect 2

The driving assistance apparatus according to claim 1, in which: the at least one of the circuit and the processor is further configured to implement: a determination unit (120) that determines whether the target direction and the moving body direction are opposing, using a first vector (VC1) that is a velocity vector of the second target and a second vector (VC2) that is a velocity vector of the moving body.

### Aspect 3

The driving assistance apparatus according to the aspect 2, in which: the determination unit determines that the target direction and the moving body direction are opposing in response to an angle formed by the first vector and the second vector being present within a range prescribed in advance, and determines that the target direction and the moving body direction are not opposing in response to the angle formed by the first vector and the second vector being present outside the range prescribed in advance.

### Aspect 4

The driving assistance apparatus according to the aspect 2 or 3, in which: the determination unit performs determination using the first vector and the second vector identified at a current point in time.

### Aspect 5

The driving assistance apparatus according to the aspect 2 or 3, in which: the determination unit performs determination using the first vector and the second vector estimated at a point in time at which the moving body and the second target are predicted to collide.

### Aspect 6

The driving assistance apparatus according to the aspect 2 or 3, in which: the determination unit performs a first determination process in which whether the target direction and the moving body direction are opposing is determined using the first vector and the second vector identified at a current point in time, and a second determination process in which whether the target direction and the moving body direction are opposing is determined using the first vector and the second vector estimated at a point in time at which the moving body and the second target are predicted to collide; and

the determination unit determines that the target direction and the moving body direction are opposing in response to the target direction and the moving body direction being determined to be opposing in both the first determination process and the second determination process.

### Aspect 7

The driving assistance apparatus according to the aspect 1, in which: the at least one of the circuit and the processor is further configured to implement: a determination unit (120) that determines whether the target direction and the moving body direction are opposing using a relative positional relationship between the second target and the moving body.

### Aspect 8

The driving assistance apparatus according to any one of the aspects 2 to 7, in which: the determination unit determines that the target direction and the moving body direction are opposing when the second target is present within an area (PAr) prescribed in advance, and determines that the target direction and the moving body direction are not opposing when the second target is not present within the area prescribed in advance.

### Aspect 9

A driving assistance method for a moving body, the moving body including a sensor that detects a target in a vicinity of the moving body, the sensor detecting a first target that is moving target present ahead of the moving body and a second target that is a moving target present to a side of the moving body, and a braking apparatus that applies a braking force to the moving body when a collision between the moving body and the moving target is predicted to occur, the driving assistance method including: adjusting the braking force, wherein adjusting the braking force includes reducing the braking force, compared to the braking force in a case where a collision with the first target is predicted, in response to a collision with the second target being predicted and a target direction that is a moving direction of the second target not being opposing a moving body direction that is a travelling direction of the moving body during turning of the moving body, and not reducing the braking force, compared to the braking force in a case where a collision with the first target is predicted, in response to the collision with the second target being predicted and the target direction being opposing the moving body direction during turning of the moving body.

### Aspect 10

A non-transitory computer-readable storage medium storing therein a driving assistance program for a moving body, the moving body including a sensor that detects a target in a vicinity of the moving body, the sensor detecting a first target that is moving target present ahead of the moving body and a second target that is a moving target present to a side of the moving body, and a braking apparatus that applies a braking force to the moving body when a collision between the moving body and the moving target is predicted to occur, the driving assistance causing at least one processor to implement: adjusting the braking force, wherein adjusting the braking force includes reducing the braking force, compared to the braking force in a case where a collision with the first target is predicted, in response to a collision with the second target being predicted and a target direction that is a moving direction of the second target not being opposing a moving body direction that is a travelling direction of the moving body during turning of the moving body, and not reducing the braking force, compared to the braking force in a case where a collision with the first target is predicted, in response to the collision with the second target being predicted and the target direction being opposing the moving body direction during turning of the moving body.

What is claimed is:

1. A driving assistance apparatus for a moving body,
the moving body including
a sensor that detects a target in a vicinity of the moving body, the sensor detecting a first target that is moving target present ahead of the moving body and a second target that is a moving target present to a side of the moving body, and
a braking apparatus that applies a braking force to the moving body when a collision between the moving body and the moving target is predicted to occur,
the driving assistance apparatus comprising:
at least one of (i) a circuit and (ii) a processor with a memory storing computer program code executable by the processor, the at least one of the circuit and the processor configured to implement:
an adjustment unit that adjusts the braking force, wherein
the adjustment unit
reduces the braking force, compared to the braking force in a case where a collision with the first target is predicted, in response to a collision with the second target being predicted and a target direction that is a moving direction of the second target not being opposing a moving body direction that is a travelling direction of the moving body during turning of the moving body, and
does not reduce the braking force, compared to the braking force in a case where a collision with the first target is predicted, in response to the collision with the second target being predicted and the target direction being opposing the moving body direction during turning of the moving body.

2. The driving assistance apparatus according to claim 1, wherein: the at least one of the circuit and the processor is further configured to implement: a determination unit that determines whether the target direction and the moving body direction are opposing, using a first vector that is a velocity vector of the second target and a second vector that is a velocity vector of the moving body.

3. The driving assistance apparatus according to claim 2, wherein:
the determination unit
determines that the target direction and the moving body direction are opposing in response to an angle formed by the first vector and the second vector being present within a range prescribed in advance, and
determines that the target direction and the moving body direction are not opposing in response to the angle formed by the first vector and the second vector being present outside the range prescribed in advance.

4. The driving assistance apparatus according to claim 2, wherein:
the determination unit performs determination using the first vector and the second vector identified at a current point in time.

5. The driving assistance apparatus according to claim 2, wherein:
the determination unit performs determination using the first vector and the second vector estimated at a point in time at which the moving body and the second target are predicted to collide.

6. The driving assistance apparatus according to claim 2, wherein:
the determination unit performs
a first determination process in which whether the target direction and the moving body direction are opposing is determined using the first vector and the second vector identified at a current point in time, and
a second determination process in which whether the target direction and the moving body direction are opposing is determined using the first vector and the second vector estimated at a point in time at which the moving body and the second target are predicted to collide; and
the determination unit determines that the target direction and the moving body direction are opposing in response to the target direction and the moving body direction being determined to be opposing in both the first determination process and the second determination process.

7. The driving assistance apparatus according to claim 1, wherein:
the at least one of the circuit and the processor is further configured to implement:
a determination unit that determines whether the target direction and the moving body direction are opposing using a relative positional relationship between the second target and the moving body.

8. The driving assistance apparatus according to claim 7, wherein:
the determination unit
determines that the target direction and the moving body direction are opposing when the second target is present within an area prescribed in advance, and
determines that the target direction and the moving body direction are not opposing when the second target is not present within the area prescribed in advance.

9. The driving assistance apparatus according to claim 3, wherein:
the determination unit performs determination using the first vector and the second vector identified at a current point in time.

10. The driving assistance apparatus according to claim 3, wherein:
the determination unit performs determination using the first vector and the second vector estimated at a point in time at which the moving body and the second target are predicted to collide.

11. The driving assistance apparatus according to claim 3, wherein:
the determination unit performs
a first determination process in which whether the target direction and the moving body direction are opposing is determined using the first vector and the second vector identified at a current point in time, and
a second determination process in which whether the target direction and the moving body direction are opposing is determined using the first vector and the second vector estimated at a point in time at which the moving body and the second target are predicted to collide; and
the determination unit determines that the target direction and the moving body direction are opposing in response to the target direction and the moving body direction being determined to be opposing in both the first determination process and the second determination process.

12. A driving assistance method for a moving body,
the moving body including
a sensor that detects a target in a vicinity of the moving body, the sensor detecting a first target that is moving target present ahead of the moving body and a second target that is a moving target present to a side of the moving body, and
a braking apparatus that applies a braking force to the moving body when a collision between the moving body and the moving target is predicted to occur,
the driving assistance method comprising:
adjusting the braking force, wherein
adjusting the braking force comprises
reducing the braking force, compared to the braking force in a case where a collision with the first target is predicted, in response to a collision with the second target being predicted and a target direction that is a moving direction of the second target not being opposing a moving body direction that is a travelling direction of the moving body during turning of the moving body, and
not reducing the braking force, compared to the braking force in a case where a collision with the first target is predicted, in response to the collision with the second target being predicted and the target direction being opposing the moving body direction during turning of the moving body.

13. A non-transitory computer-readable storage medium storing therein a driving assistance program for a moving body,
the moving body including
a sensor that detects a target in a vicinity of the moving body, the sensor detecting a first target that is moving target present ahead of the moving body and a second target that is a moving target present to a side of the moving body, and
a braking apparatus that applies a braking force to the moving body when a collision between the moving body and the moving target is predicted to occur,
the driving assistance causing at least one processor to implement:
adjusting the braking force, wherein
adjusting the braking force comprises
reducing the braking force, compared to the braking force in a case where a collision with the first target is predicted, in response to a collision with the second target being predicted and a target direction that is a moving direction of the second target not being opposing a moving body direction that is a travelling direction of the moving body during turning of the moving body, and
not reducing the braking force, compared to the braking force in a case where a collision with the first target is predicted, in response to the collision with the second target being predicted and the target direction being opposing the moving body direction during turning of the moving body.
